(19) United States
(12) Patent Application Publication
(10) Pub. No.: US 2012/0060023 A1
(43) Pub. Date: Mar. 8, 2012

(54) METHODS FOR BOOTING AN OPERATING SYSTEM USING NON-VOLATILE MEMORY

(75) Inventors: Young-Jin PARK, Incheon (KR); Sang Hoon Song, Hwaseong-si (KR)

(73) Assignee: Samsung Electronics Co., Ltd.

(21) Appl. No.: 13/188,912

(22) Filed: Jul. 22, 2011

(30) Foreign Application Priority Data
Sep. 6, 2010 (KR) 10-2010-0086841
Sep. 6, 2010 (KR) 10-2010-0086842

(51) Int. Cl. G06F 15/177

(52) U.S. Cl. 713/2

(57) ABSTRACT

A method of booting an operating system can be provided by determining file information that is associated with files accessed during booting of an operating system by a processor. Files associated with the file information can be written into a non-volatile memory. The files can be transferred from the non-volatile memory to a volatile memory during a power on self-test of the processor.

### CROSS-REFERENCE TO RELATED APPLICATIONS

The present Application claims priority under 35 U.S.C. §119, to Korean Application No. 10-2010-0086842 filed in the Korean Intellectual Property Office on Sep. 6, 2010, and to Korean Application No. 10-2010-0086841 filed in the Korean Intellectual Property Office on Sep. 6, 2010, the disclosures of which are incorporated herein by reference in their entireties.

### BACKGROUND

The inventive concept relates generally to the field of electronics, and more particularly, to computing systems.

A user can boot a computer system to utilize a desired application program installed on the computer system. An operating system (OS) can be stored on a disk, such as a hard disk drive, that is included in the computer system. The time needed to load the OS into a random access memory may result in an excessively long boot time for system.

### SUMMARY

Embodiments according to the inventive concept can provide methods and systems for booting an operating system using non-volatile memory. Pursuant to these embodiments, a method of booting an operating system can be provided by determining file information that is associated with files accessed during booting of an operating system by a processor. Files associated with the file information can be written into a non-volatile memory. The files can be transferred from the non-volatile memory to a volatile memory during a power on self-test of the processor.

In some embodiments according to the inventive concept, the can further include providing the files from the volatile memory to the processor after completion of the power on self-test. In some embodiments according to the inventive concept, the files can be providing by transferring the files from the volatile memory to a local random access memory that is accessed by the processor during booting of the operating system after completion of the power-on self test. In some embodiments according to the inventive concept, the method can further include accessing the files in the non-volatile memory using a file access table and then writing the files into the non-volatile memory.

In some embodiments according to the inventive concept, the file information can be determined by capturing the file information from a bus over which the processor accesses the files stored in the non-volatile memory during the booting of the operating system, where the file information indicates where the files are stored in the non-volatile memory or names of the files accessed. In some embodiments according to the inventive concept, the non-volatile memory can be a first non-volatile memory, where the method further includes storing the file information in a second non-volatile memory and using the file information in the second non-volatile memory in writing the files to a capture partition of the first non-volatile memory. In some embodiments according to the inventive concept, the second non-volatile memory is operatively coupled to a booting controller circuit.

In some embodiments according to the inventive concept, writing the files to the capture partition can be provided by writing the files to the capture partition in an order in which the files are accessed during booting of the operating system after completion of the power on self test. In some embodiments according to the inventive concept, the non-volatile memory can be a first non-volatile memory included in a solid state disk drive, and writing the files can be provided by writing the files associated with the file information into a second non-volatile memory included on an extension card with the processor, where the extension card is coupled to the solid state disk. The files can be transferred from the second non-volatile memory to the volatile memory that is included on the extension card with the processor, during the power on self-test of the processor.

In some embodiments according to the inventive concept, the non-volatile memory can be a hard disk drive, where the files associated with the file information can be written from the hard disk drive into a second non-volatile memory included on a card with the processor. The files can be transferred from the second non-volatile memory to the volatile memory that is included on the card with the processor, during the power on self-test of the processor.

In some embodiments according to the inventive concept, the method can further include specifying a first time in the booting of the operating system where the determining of the file information begins and specifying a second time in the booting of the operating system where the determining of the file information ends. In some embodiments according to the inventive concept, the method can also include specifying particular files that are accessed during the booting of the operating system for which file information is determined, where the particular files can be written into the non-volatile memory and whereas other files not included in the particular files written to the non-volatile memory.

In some embodiments according to the inventive concept, the processor can be included in a remote host system and the non-volatile memory and the volatile memory can be included in a solid state disk drive. The method can further include receiving a request for a requested file from the processor as part of booting the operating system after completion of the power-on self test. The requested file can be accessed in the volatile memory responsive to determining that the requested file has been transferred from the non-volatile memory to the volatile memory. The requested file can be accessed in the non-volatile memory responsive to determining that the requested file has not been transferred from the non-volatile memory to the volatile memory.

In some embodiments according to the inventive concept, a system can include a processor circuit that is configured to boot an operating system and a booting controller circuit, that is coupled to the processor circuit via a bus. The booting controller circuit can be configured to determine file information associated with files accessed during, the boot of the operating system and configured to write the files into a non-volatile memory and configured to transfer the files from the non-volatile memory to a volatile memory during a power on self-test of the processor circuit.

### BRIEF DESCRIPTION OF THE DRAWINGS

FIG. 1 is a block diagram of a computer system in some embodiments according to the inventive concept.

FIG. 2 is a block diagram of a booting controller circuit in some embodiments according to the inventive concept.

FIG. 3 is a schematic illustration of methods of booting an operating system in association with a map of a non-volatile memory in some embodiments according to the inventive concept.

FIG. 4 is a block diagram of a computer system in some embodiments according to the inventive concept.

FIG. 5 is a flowchart illustrating methods of booting an operating system in some embodiments according to the inventive concept.

FIG. 6 is a flowchart illustrating methods of booting an operating system in some embodiments according to the inventive concept.

FIG. 7 is a block diagram of a computer system in some embodiments according to the inventive concept.

FIG. 8 is a block diagram of a computer system coupled to a booting controller circuit in some embodiments according to the inventive concept.

FIG. 9 is a flowchart illustrating methods of booting an operating system in some embodiments according to the inventive concept.

FIG. 10 is a block diagram of a mobile electronic device in some embodiments according to the inventive concept.

### DESCRIPTION OF THE EMBODIMENTS ACCORDING TO THE INVENTIVE CONCEPT

The inventive concept now will be described more fully hereinafter with reference to the accompanying drawings. The inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. Thus, a first element could be termed a second element without departing from the teachings of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will further be appreciated by one of skill in the art, the present inventive concept may be embodied as methods, systems, and/or computer program products. Accordingly, the present inventive concept may take the form of an entirely hardware embodiment, an entirely software embodiment or an embodiment combining software and hardware aspects. Furthermore, the present inventive concept may take the form of a computer program product on a computer-usable storage medium having computer-usable program code embodied in the medium.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The inventive concept is also described using flowchart illustrations and block diagrams. It will be understood that each block (of the flowcharts and block diagrams), and combinations of blocks, can be implemented by computer program instructions. These program instructions may be provided to a circuit, such as a microprocessor, microcontroller or other processor, such that the instructions which execute on the processor(s) create means for implementing the functions specified in the block or blocks. The computer program instructions may be executed by the processor(s) to cause a series of operational steps to be performed by the processor(s) to produce a computer implemented process such that the instructions which execute on the processor(s) provide steps for implementing the functions specified in the block or blocks.

Accordingly, the blocks support combinations of means for performing the specified functions, combinations of steps for performing the specified functions and program instruction means for performing the specified functions. It will also be understood that each block, and combinations of blocks, can be implemented by special purpose hardware-based systems which perform the specified functions or steps, or combinations of special purpose hardware and computer instructions.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

It is understood that each block of the illustrations, and combinations of blocks in the illustrations can be implemented by computer program instructions. These computer program instructions may be provided to a circuit to produce a machine, such that the instructions, which execute via the processor of the computer or other programmable data processing apparatus, create means for implementing the functions specified in the block and/or flowchart block or blocks.

These computer program instructions may be stored in a computer-readable memory that can direct a computer or other programmable data processing apparatus to function in a particular manner, such that the instructions stored in the computer-readable memory produce an article of manufacture including instruction means which implement the function specified in the block diagrams and/or flowchart block or blocks.

The computer program instructions may be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagrams and/or flowchart block or blocks.

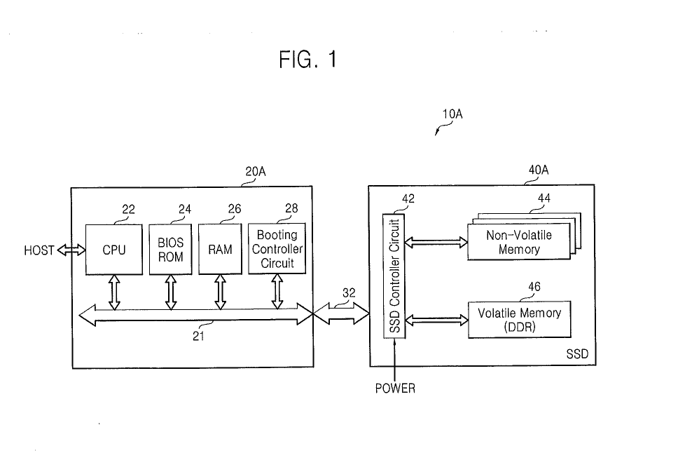

Referring to FIGS. 1, 2, and 3, a computer system 10A is shown, which may be implemented as at least a portion of a general purpose computer system, sometimes referred to as a personal computer (PC), a mobile computing device, or the like. It will be understood that the computer system 10A can be configured to boot an operating system, such as Windows™ from Microsoft Corporation, Redmond, Wash., Palm OS, Symbian OS, Cisco IOS, VxWorks, Unix, Linux, MAC OS, or IOS configured for mobile electronic devices.

The computer system 10A includes a control system 20A and a data storage device 40A. The control system 20A includes a central processing unit (CPU) 22, which can be a microprocessor circuit sometimes referred to herein as a processor circuit, a basic input/output system (BIOS) read only memory (ROM) 24, a random access memory (RAM) 26, and a (rapid) booting controller circuit 28. In some embodiments according to the inventive concept, the booting controller circuit 28, can include a capture module 28-1 and a memory 28-2 coupled to the capture module 28-1.

In some embodiments according to the inventive concept, the control system 20A can be an extension card, which is configured for mounting to, for example, a motherboard via a connector. As such, the control system 20A may be configured to provide an interface between the data storage device 40A and another processor circuit, which may function as the host connected to the control system 20A and may be mounted to the motherboard.

In some embodiments according to the inventive concept, the data storage device 40A can be a solid state drive (SSD) including an SSD controller circuit 42 used to interface to at least one non-volatile memory 44 and a volatile memory 46. In some embodiments according to the inventive concept, the non-volatile memory 44 can be an Electrically Erasable Programmable Read-Only Memory (EEPROM), such as a NAND flash memory. Other types of non-volatile memory can be used. In some embodiments according to the inventive concept, the volatile memory 46 can be a Double Data Rate Synchronous Dynamic Random Access Memory (DDR SDRAM). Other types of volatile memory can be used.

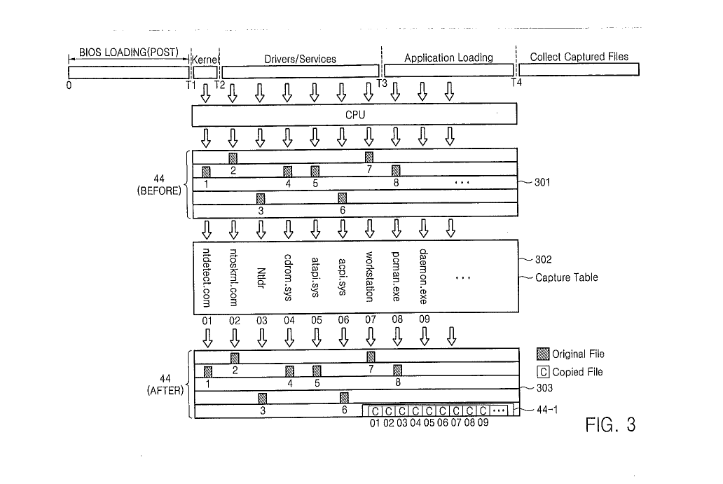

Referring to FIG. 3, when power is initially supplied to the control system 20A, the CPU 22 senses the supply of the power, and transfers control of the control system 20A to a BIOS program stored in the BIOS ROM 24, which is configured to coordinate overall operations of the control system 20A to perform a boot operation, which is sometimes referred to herein as “booting” or a “booting operation.” It will be understood that the boot operation is generally configured to access code stored in a memory, which is provided for access by the CPU 22, to execute the operating system.

During an initial portion of the boot operation at time 0, the BIOS program stored in the BIOS ROM 24 is loaded and the CPU 22 performs a Power On Self Test (POST), which is configured to test the basic functions of the CPU 22, and identify devices associated with the computer system 10A before the boot operation proceeds further. Once the POST is successfully completed at time T1, the BIOS accesses files stored in the non-volatile memory 44, which are needed to boot the operating system. The accessed files are copied from the non-volatile memory 44 to the RAM 26, over the bus 21.

In some embodiments according to the inventive concept, the capture module 28-1 may determine file information associated with the files stored in the non-volatile memory 44 that are accessed during the boot operation beginning at time T1. For example, the capture module 28-1 can determine the names, locations (in the non-volatile memory 44) and sizes of the files needed to provide the kernel of the operating system that are accessed during the time interval from T1 to T2. Other information associated with the accessed files can also be determined.

Still referring to FIG. 3, the capture module 28-1 may continue to determine the file information associated with the accessed files from the time interval of T2 to T3. For example, the capture module 28-1 can determine the names, locations (in the non-volatile memory 44) and sizes of the files needed to provide the drivers and services of the operating system that are accessed, during the time interval from T2 to T3. Still further, file information associated with applications and other classes of computer programs can be determined during other time intervals in the booting process, such as from time T3 to T4. In some embodiments according to the inventive concept, a user of the computer system 10A can define the time intervals when the file information is determined. Still further, in some embodiments, only a portion of the time intervals may be defined. For example, in some embodiments, the user may define the time intervals so that only the file information associated with the Applications are determined. In other words, the capture module 28-1 may be active from T3 to T4, but inactive during other times during the booting operation.

As shown in a non-volatile memory map 301 in FIG. 3, the files for which file information is determined can be stored in a non-sequential and non-contiguous manner in the non-volatile memory 44. As appreciated by the present inventors, accessing the files from the non-volatile memory 44 in such a manner may lead to excessively long booting times.

In some embodiments according to the inventive concept, the determined file information is stored in a capture table 302 in the memory 28-2 included in the booting controller circuit 28. It will be understood that other information, such as that used to operate the capture module 28-1 can also be stored in the memory 28-2. In still other embodiments according to the inventive concept, file information determined by the capture module 28-1 may be stored in the non-volatile memory 44 via the SSD controller circuit 42, where the capture module 28-1 is embodied as software.

In some embodiments according to the inventive concept, some of the files for which the file information can be determined include: ntdedect.com, ntoskrnl.com, ntldr, cdrom.sys, atapi.sys, acpi.sys, workstation, paman.exe, daemon.exe, etc. which may be accessed during a typical boot operation. Other files may also be accessed for which file information is determined. As shown in FIG. 3, the file information associated with the accessed files can be stored in the capture table 302 during the booting operation in the order in which those files are accessed.

In some embodiments according to the inventive concept, the capture module 28-1, may determine the file information associated with the files accessed during the boot operation using an approach sometimes referred to as a “snapshot” where the capture module 28-1 determines the state of the computer system 10A, for example, when the booting operation is complete. In some embodiments according to the inventive concept, the capture module 28-1, may determine the file information associated with the files accessed during the boot operation using an approach sometimes referred to as “hooking” where the capture module 28-1 determines the file information by, for example, intercepting the file information via function calls, messages, and/or events that can be passed between components of the software used for the boot operation. In some embodiments according to the inventive concept, “hooking” can be implemented by the capture module 28-1 monitoring transfers via the bus 21 over which the files are transferred from the non-volatile memory 44.

Still referring to FIG. 3, the capture module 28-1 provides for the creation of a capture partition 44-1 within the non-volatile memory map 303. In some embodiments according to the inventive concept, the files associated with the file information stored in the capture table 302 are written into the capture partition 44-1. In particular, the files can be stored sequentially in the same order in which the files were accessed during the booting operation. For example, as shown in the non-volatile memory map 303, the file accessed first after T1 (ntdedect.com), is stored in the first portion of the capture partition 44-1, the file accessed after ntdedect.com (ntoskrnl.com), is stored in the next sequential portion of the capture partition 44-1, and so on as shown in the non-volatile memory map 303. In some embodiments according to the inventive concept, a file access table can be used to access the files associated with the file information.

In some embodiments according to the inventive concept, the files associated with the file information are transferred to the capture partition 44-1 after the boot operation is complete. In some embodiments according to the inventive concept, the files associated with the file information are written to the capture partition 44-1 during the booting operation when idle time on the bus 21 is available. In some embodiments according to the inventive concept, the files associated with the file information are written using the SSD controller circuit 42. It will be understood that writing the files can include either writing a copy of the files into the capture partition 44-1 so that at least two versions of the files are maintained in the non-volatile memory 44 or moving the files to the capture partition 44-1 so that one version of the files is maintained in the non-volatile memory 44.

As appreciated by the present inventors, if the files accessed during the boot operation are re-organized in the non-volatile memory into the order in which the files are accessed during booting, the time needed to access those files during a subsequent boot operation may be reduced compared to the process described above in reference to time intervals T1 to T4, which may allow for faster subsequent boot operations.

During the next POST, when power is supplied to both the control system 20A and the SSD 40A, the SSD controller circuit 42 can transfer the files stored in the capture partition 44-1 into the volatile memory 46, so that the CPU 22 can access the files in the volatile memory 46, rather than from the non-volatile memory 44, which may provide for faster boot times. In some embodiments according to the inventive concept, the files are transferred to the volatile memory 46 simultaneously with the POST. In some embodiments according to the inventive concept, the transfer of files to the volatile memory 46 begins during POST, and may be complete by the end of POST. In some embodiments according to the inventive concept, the transfer of files to the volatile memory 46 begins during POST, but may not complete before POST completes, whereupon the transfer may continue while simultaneously allowing the CPU 22 to access the files that actually have been transferred to the volatile memory 46.

After the transfer is complete, the SSD controller circuit 42 can change a file access path so that the CPU 22 may access the files in the volatile memory 46 rather than from the non-volatile memory 44. Accordingly, the CPU 22 may access the volatile memory 46 to load the transferred files to the RAM 26, which may provide the files for a warm boot operation. If the transfer is not completed even at the start of the warm boot, the transfer and the warm boot may be conducted simultaneously. For example, the CPU 22 may perform a portion of the warm boot using at least one file that has been loaded into the RAM 26 while the transfer is on-going.

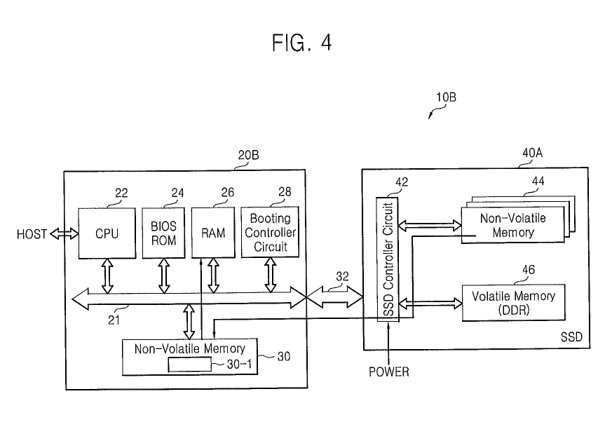

FIG. 4 is a block diagram of a computer system 10B in some embodiments according to the inventive concept. Referring to FIG. 4, an extension card 20B includes the components described above in reference to FIG. 1 included in the control system 20A. The extension card 20B further includes a non-volatile memory 30. In some embodiments according to the inventive concept, the memory 28-2 can be the non-volatile memory utilized by the extension card 20B. In operation, the determined file information is used to write the accessed files into a capture partition 30-1 in the non-volatile memory 30.

During a subsequent POST, the files can be transferred from the capture partition 30-1 to a volatile memory on the extension card 20B. In some embodiments according to the inventive concept, the volatile memory on the extension card 20B can be the RAM 26. After completion of the transfer, the CPU 22 may change a file access path so that the CPU 22 may access the RAM 26 rather than the non-volatile memory 30 or 44, during the warm boot operation.

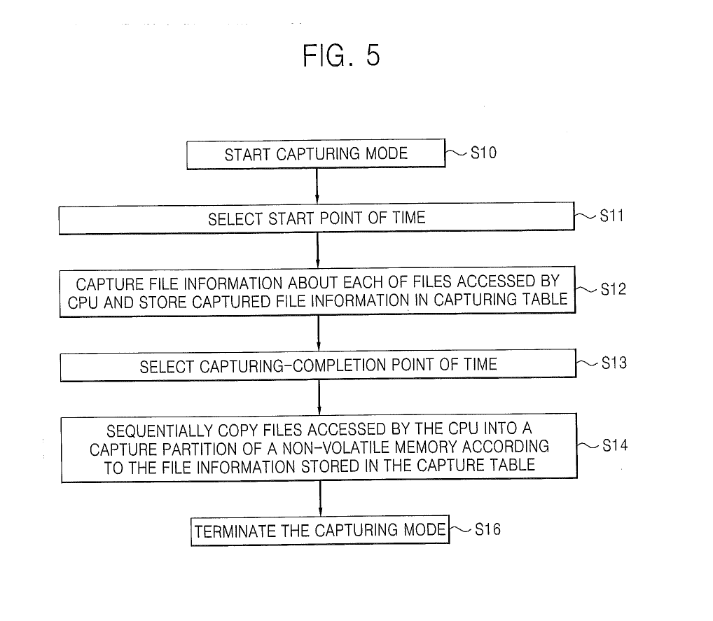

FIG. 5 is a flowchart illustrating methods of booting an operating system using the booting controller circuit 28 in some embodiments according to the inventive concept. A user may activate a program according to the inventive concept to enable a capture mode wherein file information is determined for files accessed during a boot operation. The program may be executed by the booting controller circuit 28 and may be stored in the booting controller 28 or the non-volatile memory 44. In particular, the capture mode can be provided by operation of the capture module 28-1.

In operation S10, the booting controller circuit 28 starts the capture mode according to a selection made by the user via, for example, a command received from the host system. In some embodiments according to the inventive concept, the time intervals when the capture mode is enabled/disabled can be provided by the user as part of the command in operation S11. In particular, the capture mode may have a default start time that is immediately after completion of POST (e.g., time T1 of FIG. 3). Other enable times may be selected by the user. At this time, the SSD controller circuit 42 may generate the capture partition 44-1 in the non-volatile memory 44. In some embodiments according to the inventive concept, the capture partition 30-1 may be generated under the control of the booting controller circuit 28.

In operation S12, the booting controller circuit 28 (via, for example, the capture module 28-1) may determine file information about each of the files accessed by the CPU 22 in the non-volatile memory area, and may store the file information in the capture table 302 of the memory 28-2, the non-volatile memory 44, or the non-volatile memory 30.

In operation S13, a time when the capture mode is disabled (e.g., time T4 of FIG. 3) can be defined. In some embodiments according to the inventive concept, the time when the capture mode is disabled can be provided by the user as part of the command in operation S11 or using another approach. In some embodiments according to the inventive concept, a default time when the capture mode is disabled can be a time when the computer system allows users to log-in.

In operation S14, the booting controller circuit 28 using, for example the capture module 28-1, may control an operation of the SSD controller circuit 42 to sequentially write the accessed files associated with the file information into the capture partition 44-1 of the non-volatile memory 44. In some embodiments according to the inventive concept, the accessed files associated with the file information are written into the capture partition 30-1 of the non-volatile memory 30, where the capture table is in the memory 28-2, in the non-volatile memory 44, or in the non-volatile memory 30.

For example, in operation S14, the booting controller circuit 28 using, for example the capture module 28-1, may control an operation of the SSD controller circuit 42 to collect the files accessed by the CPU 22 and store those files sequentially in the capture partition 44-1 of the non-volatile memory 44 or in the capture partition 30-1, based on the file information stored in the capture table 302 in the memory 28-2, the non-volatile memory 44, or the non-volatile memory 30. The capture mode can then be terminated in S16.

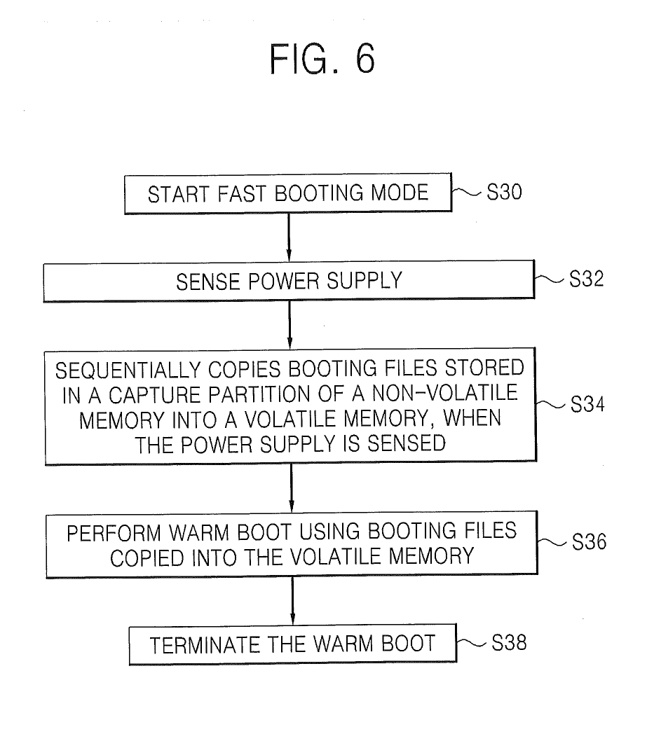

FIG. 6 is a flowchart illustrating methods of booting an operating system in some embodiments according to the inventive concept. As described above, all of the file information associated with the files accessed by the CPU 22 are sequentially stored in the capture partition 44-1 (or 30-1) of the non-volatile memory 44 (or 30). In operation S30, a user can enable a fast boot mode. In operation S32, the SSD controller circuit 42 detects that power is supplied to the SSD 40A and the booting controller circuit 28 also detects the power supplied to the control system 20B.

In operation S34, the SSD controller circuit 42 sequentially transfers the files stored in the capturing partition 44-1 of the non-volatile memory 44 into the volatile memory 46, when the power is detected. For example, the SSD controller circuit 42 sequentially transfers the files while POST is being conducted according to the BIOS program stored in the BIOS ROM 24.

After the transfer is complete, the files copied from the non-volatile memory 44 into the volatile memory 46 are loaded into the RAM 26 to perform the warm boot operation under the control of the CPU 22. The time needed to load the files from the volatile memory 46 into the RAM 26 may be significantly less than that needed to load from the non-volatile memory 44 into the RAM 26. Accordingly, the CPU 22 may perform the warm boot operation using the files loaded into the RAM 26 via volatile memory 46, in operation S36. Thereafter, the warm booting is concluded, in operation S38.

When at least one application is included in the files stored in the capture partition 44-1 according to a selection made by the user, the time needed to transfer the application from the volatile memory 46 to the RAM 26 may be significantly less than that needed to transfer the application from the non-volatile memory 44 into the RAM 26.

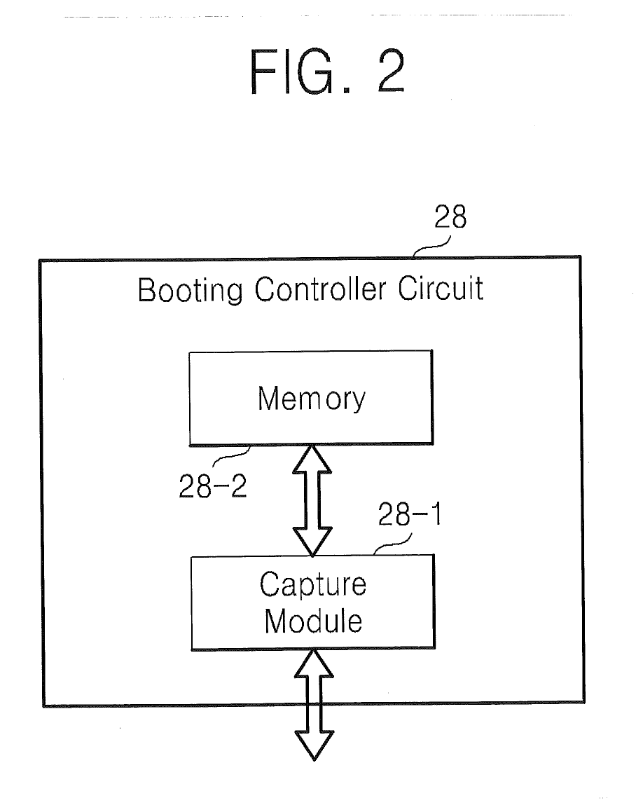

In operation S34, the booting controller 28 of FIG. 2 also sequentially copies the booting image files stored in the capturing partition 30-1 of the non-volatile memory 30 into the volatile memory 26, when POWER is sensed, for example, while POST is being executed according to the BIOS program stored in the BIOS ROM 24.

After the copying is completed, the CPU 22 also executes warm booting by using the booting image files loaded into the RAM 26, in operation S36. Thereafter, the warm booting is terminated in operation S38.

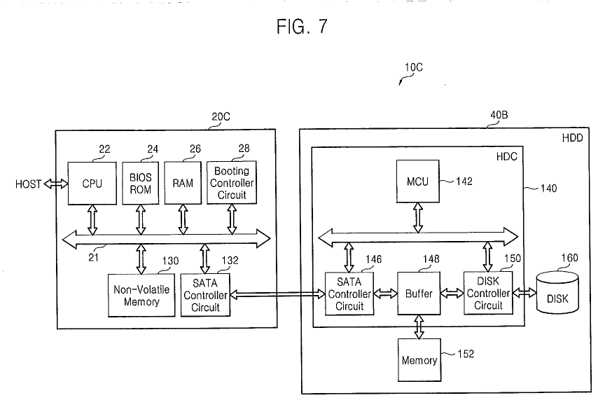

FIG. 7 is a block diagram of a computer system 10C in some embodiments according to the inventive concept. Referring to FIG. 7, the computer system 10C includes a control system 20C and a data storage device 40B. The control system 20C includes a CPU 22, a BIOS ROM 24, a RAM 26, a booting controller circuit 28, a non-volatile memory 130, and a first SATA controller circuit 132. The data storage device 40B can be implemented as a hard disk drive (HDD) including an HDD controller circuit 140, a memory 152, and a disk 160, that provides a magnetic storage medium. In some embodiments according to the inventive concept, the control system 20C may be implemented as an extension card.

The HDD controller circuit 140 includes a main control unit (MCU) 142, a second SATA controller circuit 146, a buffer 148, and a disk controller circuit 150. The MCU 142 is configured to control at least one of the operations of the second SATA controller circuit 146, the buffer 148, and the disk controller circuit 150.

During a write operation, write data from the HOST is stored in the RAM 26 and is transmitted to the second SATA controller circuit 146 via the first SATA controller circuit 132 under the control of the CPU 22. The first and second SATA controller circuits 132 and 146 include interface functions to provide support for the SATA protocol.

The buffer 148 buffers the write data transmitted from the second SATA controller circuit 146 and stores the buffered write data in the memory 152. The disk controller circuit 150 accesses the write data in the memory 152, and writes the accessed data to a storage region of the disk 160 that is designated by a write address.

During a read operation, the disk controller circuit 150 fetches read data from a storage region of the disk 160 which is designated by a read address, and stores the read data in the memory 152 via the buffer 148. The second SATA controller circuit 146 reads data from the memory 152 via the buffer 148 and transmits the read data to the first SATA controller circuit 132. The first SATA controller 132 stores the read data in the RAM 26, and the CPU 22 transfers the read data stored in the RAM 26 to the HOST.

Similar to the operation of the booting controller circuit 28 shown in FIG. 5, when the capture mode starts (based on the user input), the booting controller circuit 28 may generate a capture partition in the non-volatile memory 130. The capture module 28-1 of the booting controller circuit 28 may determine the file information associated with each of the files stored on the disk 160 that are accessed by the CPU 22 during the boot operation. The file information may be stored in the capture table 302 in the memory 28-2. The capture module 28-1 sequentially writes the files associated with the file information in the capture partition 303 of the non-volatile memory 130.

The booting controller circuit 28 detects that power is supplied to the control system 20C and sequentially transfers the files sequentially stored in the capture partition 303 into the RAM 26, while POST is being conducted according to the BIOS program stored in the BIOS ROM 24.

After the transfer is complete, the CPU 22 can execute a warm boot operation by using the files transferred into the RAM 26. Since the computer system 10C executes the warm boot operation using the files stored in the non-volatile memory 130 rather than those stored on the disk 160, the time needed for the boot operation may be reduced.

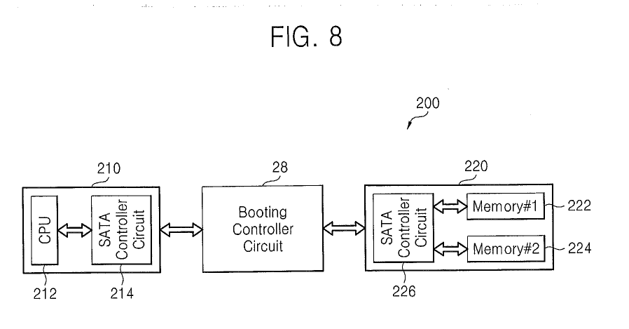

FIG. 8 is a block diagram of a computer system coupled to a booting controller circuit 28 in some embodiments according to the inventive concept. A computer system 200 includes a first SATA device 210, a second SATA device 220, and the booting controller circuit 28. The booting controller circuit 28 is connected between the first SATA device 210 and the second SATA device 220.

The first SATA device 210 includes a first SATA controller circuit 214 capable of communicating with a CPU 212, and the second SATA device 220 includes a second SATA controller circuit 226 capable of communicating with a plurality of data storage media including first and second data storage media 222 and 224.

When capture mode is enabled during a boot operation, the capture module 28-1 of the booting controller circuit 28 determines file information associated with the files stored in the first data storage medium 222 (for example, NAND flash memory) that are accessed by the CPU 212 and stores the determined file information in the capture table 302 in the memory 28-2 or in the first data storage medium 222. In some embodiments according to the inventive concept, the file information is determined using a snapshot or hooking approach.

The capture module 28-1 in the booting controller circuit 28 may sequentially store the files accessed by the CPU 212 in a capture partition 303 in the first data storage medium 222, under the control of the second SATA controller circuit 226, based on the file information.

In a rapid booting mode set by the user, the second SATA device 220 transfers the files in the capture partition 303 to the second data storage medium 224 (for example, DRAM), when the second SATA device 220 is provided with power, that is, while POST is being performed in the first SATA device 210. After the transfer is complete, the CPU 212 performs a warm boot operation by accessing the files stored in the second data storage medium 224 rather than the first data storage medium 222.

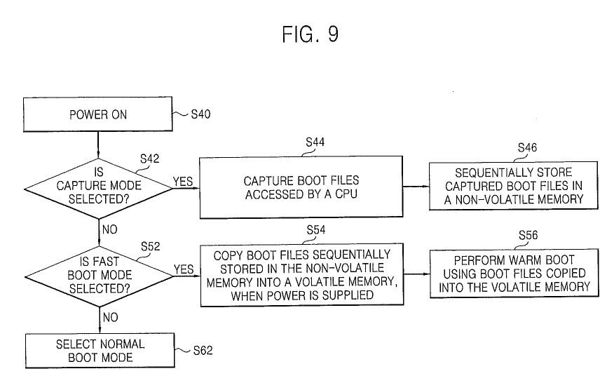

FIG. 9 is a flowchart illustrating methods of booting an operating system in some embodiments according to the inventive concept. In operation S40, power is supplied to the computer system 10A, 10B, or 10C. In operation S42, a user may select a capture mode in some embodiments according to the inventive concept.

When the capture mode is selected by the user, in operation S44 the booting controller circuit 28, determines the file information associated with the files accessed by the CPU 22 from a data storage medium (for example, the non-volatile memory 44 or the disk 160) during the boot operation and sequentially transfers the files to the non-volatile memory 44, 30, or 130, in operation S46. In some embodiments according to the inventive concept, the determined file information includes information that identifies particular files accessed during the boot operation that are to be captured. In some embodiments according to the inventive concept, the determined file information includes information that identifies all the files that are accessed during the boot operation.

In some embodiments according to the inventive concept, the file information includes a copy or image of the file that is accessed by the CPU 22 during the boot operation so that the accessed file is captured during the boot operation, which may then be written to the capture partition 303.

When the capture mode is not selected, but fast booting mode is selected by the user in operation S52, the data storage device 40A or 40B transfers the files from capture partition 303 in the non-volatile memory 44, 30, or 130 into the volatile memory 46, the volatile memory 26, or the volatile memory 26, when power is supplied to the control system 20A, 20B, or 20C and the data storage device 40A or 40B, in operation S54. In some embodiments according to the inventive concept, the transfer is performed during POST.

After the transfer is complete, the CPU 22 performs a warm boot operation using the files transferred from the capture partition 44-1 in the non-volatile memory 44, 30, or 130 to the volatile memory 46, the volatile memory 26, or the volatile memory 26, in operation S56.

When a normal boot operation is selected by the user in operation S62, however, the CPU 22 may perform the warm boot operation by accessing the files stored in a memory region other than the capture partition 44-1 or the files stored on the disk 160.

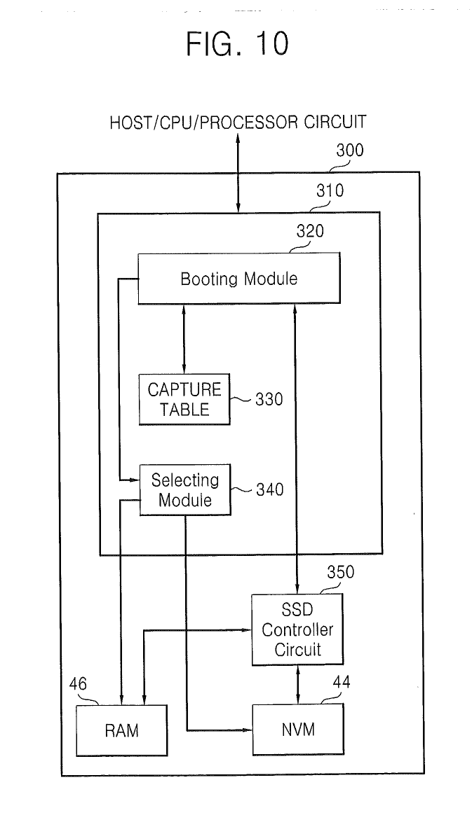

FIG. 10 is a block diagram of a mobile electronic device in some embodiments according to the inventive concept. The data storage device 300 can be implemented in an SSD and can include a booting controller circuit 310, an SSD controller circuit 350, at least one non-volatile memory 44, and a volatile memory 46.

The SSD controller circuit 350 may control data access operations of the at least one non-volatile memory 44 and data access operations of the volatile memory 46. The data access operations can include write and/or read operations.

For example, the SSD controller circuit 350 may control data access operations of the at least one non-volatile memory 44 and data access operations of the volatile memory 46 under the control of a processor circuit included in the SSD 300. In some embodiments according to the inventive concept, the processor circuit may control operations of the booting controller circuit 310.

A booting module 320 included in the booting controller circuit 310 may determine, in operation S44, the file information associated with files stored in the non-volatile memory 44 that are accessed by the CPU during a boot operation when the capture mode is selected by the user in operation S42. The booting module 320 may write the determined file information into the capture table 330 in the booting controller circuit 310. In some embodiments according to the inventive concept, the capture table 330 may be included in a memory in the booting controller circuit 310 or in the non-volatile memory 44.

The booting module 320 may sequentially transfer the files associated with the file information stored in the capture table 330 to the capturing partition 44-1 of the non-volatile memory 44 in operation S46. In particular, when power is supplied to the SSD 300 in the fast booting mode, the SSD controller circuit 350 sequentially transfers the files stored in the capture partition 44-1 to the volatile memory 46 (for example, a DRAM) under the control of the booting controller circuit 310 while POST is being conducted by the CPU, in operation S54.

After the transfer is complete or simultaneously with at least a portion of the transfer being executed, if the booting module 320 receives a request from the CPU to transmit a file needed to perform a warm boot operation, the booting module 320 determines whether the requested file is stored in the volatile memory 46, by referring to the file information stored in the capture table 330.

If it is determined that the file requested by the CPU is stored in the volatile memory 46, a selection module 340, accesses the volatile memory 46 and transmits the requested file to the CPU. Accordingly, the CPU may perform a warm boot operation using the file stored in the non-volatile 46, in operation S56.

If it is determined, however, that the file requested by the CPU is not stored in the volatile memory 46, the selection module 340 instead accesses the non-volatile memory 44 and transmits the requested file to the CPU. The booting module 320 may generate a control signal used to control a selection operation of the selection module 340.

When the normal booting mode is selected by the user in operation S62, the booting module 320 may transmit the files needed for a boot operation from the non-volatile memory 44 to the CPU via the SSD controller 350. Accordingly, the CPU may perform a warm boot operation using the original files stored in the non-volatile memory 44.

In other words, in some embodiments according to the inventive concept, the booting controller circuit 28 or 310 may copy all of the files stored in the non-volatile memory 44 or 160 needed for a boot operation into the volatile memory 46 or 26, while POST is being conducted by the CPU, that is, while BIOS loading is being performed. Accordingly, the CPU can access a volatile memory, instead of a non-volatile memory, to perform a warm boot operation thereby allowing faster booting.

While the present inventive concept has been particularly shown and described with reference to exemplary embodiments thereof, it will be understood that various changes in form and details may be made therein without departing from the spirit and scope of the following claims.

1. A method of booting an operating system comprising:
determining file information associated with files accessed during booting of an operating system by a processor;
writing files associated with the file information into a non-volatile memory; and
transferring the files from the non-volatile memory to a volatile memory during a power on self-test of the processor.

2. The method according to claim 1 further comprising:
providing the files from the volatile memory to the processor after completion of the power on self-test.

3. The method according to claim 2 wherein providing comprises:
transferring the files from the volatile memory to a local random access memory accessed by the processor during booting of the operating system after completion of the power-on self test.

4. The method according to claim 1 wherein writing further comprises:
accessing the files in the non-volatile memory using a file access table; and then
writing the files into the non-volatile memory.

5. The method according to claim 1 wherein determining comprises capturing the file information from a bus over which the processor accesses the files stored in the non-volatile memory during the booting of the operating system, wherein the file information indicates where the files are stored in the non-volatile memory or names of the files accessed.

6. The method according to claim 5 wherein the non-volatile memory comprises a first non-volatile memory, the method further comprising:
storing the file information in a second non-volatile memory; and
using the file information in the second non-volatile memory in writing the files to a capture partition of the first non-volatile memory.

7. The method according to claim 6 wherein the second non-volatile memory is operatively coupled to a booting controller circuit.

8. The method according to 6 wherein writing the files to the capture partition comprises writing the files to the capture partition in an order in which the files are accessed during booting of the operating system after completion of the power on self test.

9. The method according to claim 1 wherein the non-volatile memory comprises a first non-volatile memory included in a solid state disk drive, wherein writing the files comprises writing the files associated with the file information into a second non-volatile memory included on an extension card with the processor, the extension card being coupled to the solid state disk; and
wherein transferring comprises transferring the files from the second non-volatile memory to the volatile memory, included on the extension card with the processor, during the power on self-test of the processor.

10. The method according to claim 1 wherein the non-volatile memory comprises a hard disk drive, wherein writing the files comprises writing the files associated with the file information from the hard disk drive into a second non-volatile memory included on a card with the processor; and
wherein transferring comprises transferring the files from the second non-volatile memory to the volatile memory, included on the card with the processor, during the power on self-test of the processor.

11. The method according to claim 1 further comprising:
specifying a first time in the booting of the operating system where the determining of the file information begins; and
specifying a second time in the booting of the operating system where the determining of the file information ends.

12. The method according to claim 1 further comprising:
specifying particular files accessed during the booting of the operating system for which file information is determined;
wherein writing the files associated with the file information comprises writing the particular files into the non-volatile memory and avoiding writing other files not included in the particular files to the non-volatile memory.

13. The method according to claim 1 further comprising:
specifying particular applications accessed during the booting of the operating system for which file information is determined; and
wherein writing the files associated with the file information comprises writing the particular applications into the non-volatile memory and avoiding writing other files not included in the particular applications to the non-volatile memory.

14. The method according to claim 1 wherein the non-volatile memory comprises a flash memory semiconductor device.

15. The method according to claim 1 wherein writing comprises starting writing the files associated with the file information into the non-volatile memory before booting the operating system is complete.

16. The method according to claim 1 wherein transferring comprises starting transferring the files from the non-volatile memory to the volatile memory before the power on self-test of the processor is complete.

17. The method according to claim 1 wherein the processor is included in a remote host system and the non-volatile memory and the volatile memory are included in a solid state disk drive, the method further comprising:
receiving a request for a requested file from the processor as part of booting the operating system after completion of the power-on self test;
accessing the requested file in the volatile memory responsive to determining that the requested file has been transferred from the non-volatile memory to the volatile memory; and
accessing the requested file in the non-volatile memory responsive to determining that the requested file has not been transferred from the non-volatile memory to the volatile memory.

18. The method according to claim 1 wherein determining further comprises:
storing the file information in the non-volatile memory in a capture partition in an order in which the files are accessed during booting of the operating system after completion of the power on self test.

19. A method of booting comprising:
copying files previously fetched from a non-volatile memory during a power-on boot sequence of an operating system, to a volatile memory during a subsequent power on self test of a processor used to boot the operating system; and
booting the operating system using the previously fetched files in the volatile memory.

20-23. (canceled)

24. A method of booting an operating system comprising:
booting an operating system after a first power-on self test of a processor;
determining file information during a specified interval of the booting indicating which files are copied from a non-volatile memory to a local volatile memory used by the processor to boot the operating system;
copying files associated with the file information into a capture partition in the non-volatile memory in an order in which the files were accessed during booting of the operating system; and then
detecting a start of a second power-on self test of the processor; and
starting transferring the files from the capture partition of the non-volatile memory to a volatile memory during the second power-on self test of the processor.

25-37. (canceled)
